(19) United States
(12) Patent Application Publication
(10) Pub. No.: US 2025/0126188 A1
(43) Pub. Date: Apr. 17, 2025

(54) METHOD AND DEVICE FOR HIGH-SPEED AND LOW-LATENCY PACKET PROCESSING USING SMART NETWORK DEVICES

(71) Applicant: Samsung Electronics Co., Ltd., Gyeonggi-do (KR)

(72) Inventors: Donghyun JE, Gyeonggi-do (KR); Dongmyung KIM, Gyeonggi-do (KR); Sunghwan KIM, Gyeonggi-do (KR); Younggyoun MOON, Gyeonggi-do (KR)

(21) Appl. No.: 18/912,961

(22) Filed: Oct. 11, 2024

(30) Foreign Application Priority Data
Oct. 11, 2023 (KR) 10-2023-0135357

(51) Int. Cl. H04L 69/22; H04L 45/00

(52) U.S. Cl. CPC H04L 69/22; H04L 45/38

(57) ABSTRACT

Disclosed is a fifth generation (5G) communication system or a sixth generation (6G) communication system for supporting higher data rates beyond a fourth generation (4G) communication system such as long term evolution (LTE). A method performed by a first device performing packet processing in a mobile communication system includes receiving, from a second device performing packet processing, a packet processing allocation request message requesting packet processing, receiving a packet, determining a packet processing method of the received packet based on the packet processing allocation request message, and performing packet processing of the received packet based on the determined packet processing method.

### CROSS-REFERENCE TO RELATED APPLICATION(S)

This application is based on and claims priority under 35 U.S.C. § 119 to Korean Patent Application No. 10-2023-0135357, which was filed in the Korean Intellectual Property Office on Oct. 11, 2023, the entire disclosure of which is incorporated herein by reference.

### BACKGROUND

### 1. Field

This disclosure relates generally to a method and device for performing packet processing in a mobile communication system, and more particularly, to a method and device for performing high-speed and low-latency packet processing using a smart network device (SND).

### 2. Description of Related Art

Based on the development of wireless communication, technologies have been developed mainly for services targeting humans, such as voice calls, multimedia services, and data services. Following the commercialization of 5th-generation (5G) communication systems, it is expected that the number of connected devices will exponentially grow and will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. To provide various services by connecting hundreds of billions of devices and things in the 6th-generation (6G) era, there have been ongoing efforts to develop improved 6G communication systems, which are referred to as beyond-5G systems.

6G communication systems are expected to be commercialized around 2030 and will have a peak data rate of tera (1,000 giga)-level bps and a radio latency less than 100 microseconds (μsec), and thus will be 50 times as fast as 5G communication systems and have the 1/10 radio latency thereof.

To realize such a high data rate and an ultra-low latency, it has been considered to implement 6G communication systems in a terahertz (THz) band (for example, 95 GHz to 3 THz bands). It is expected that, due to severe path loss and atmospheric absorption in the THz bands than those in millimeter wave (mmWave) bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. There has been ongoing discussion on new technologies for improving the coverage of THz-band signals, such as metamaterial-based lenses and antennas, orbital angular momentum (OAM), and reconfigurable intelligent surface (RIS).

Moreover, to improve the spectral efficiency and the overall network performances, the following technologies have been developed for 6G communication systems: a full-duplex technology for enabling an uplink (UL) transmission and a downlink (DL) transmission to simultaneously use the same frequency resource, a network technology for utilizing satellites, high-altitude platform stations (HAPS), and the like in an integrated manner, an improved network structure for supporting mobile base stations (BSs) and the like and enabling network operation optimization and automation and the like, a dynamic spectrum sharing technology via collision avoidance based on a prediction of spectrum usage, an use of artificial intelligence (AI) in wireless communication for improvement of overall network operation by utilizing AI from a designing phase for developing 6G and internalizing end-to-end AI support functions, and a next-generation distributed computing technology for overcoming the limit of user equipment (UE) computing ability through reachable super-high-performance communication and computing resources (such as mobile edge computing (MEC), clouds, and the like) over the network.

By designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience to be realized. Particularly, it is expected that services such as truly immersive extended reality (XR), high-fidelity mobile hologram, and digital replica could be provided through 6G communication systems. Services such as remote surgery for security and reliability enhancement, industrial automation, and emergency response will be provided through the 6G communication system such that the technologies could be applied in various fields such as industry, medical care, automobiles, and home appliances.

Conventionally, a BS performs packet processing within a virtualized platform that utilizes a general purpose central processing unit (CPU) designed for various complex calculations in addition to calculations required to perform actual packet processing calculations. This causes unnecessary use of resources.

Virtualized platforms are composed of multiple layers, and additional calculations caused by multiple layers of the virtualization platform result in a delay time.

Particularly, when packet processing is performed through numerous layers within a virtualized platform, as in the conventional art, there is a problem in that performing packet processing on a virtualized platform is expensive. The virtualized platform performs packet processing calculations by utilizing a general purpose CPU designed to perform general calculations, control, input/output, and various complex calculations. However, many operations that may be performed on a general purpose CPU at a BS are not necessary for packet processing at an actual BS. The virtualized platform is constituted as a server; thus, a server dedicated memory is required, and there are chipsets for managing and controlling a CPU, memory, and peripheral devices. Since such a virtualized platform is constituted as a general purpose server, the product is expensive. In some layers (e.g., PDCP layer) that perform packet processing, data may be encrypted redundantly even though it has already been encrypted. When a packet processing operation amount of the BS is analyzed, approximately 70% of the operation amount was used for security operation.

Therefore, in using an existing CPU, there is a problem that packet processing (or security calculation of packet processing) of the actual BS incurs a high cost.

Furthermore, performing packet processing on a virtualized platform causes additional delay. More specifically, a virtualized platform is composed of several layers. The virtualized platform has a server itself and a virtualization supervisor that operates the server. A software (SW)-based mobile communication BS operates in a virtual machine (VM) form in a virtualized space allocated by the virtualization supervisor. Therefore, as a virtualized platform is used, to transmit and receive a new packet, the new packet should pass through the virtualization supervisor area. In this case, additional calculations may occur due to the use of a virtualized platform, and additional delay time may occur in packet processing.

Thus, a larger packet processing amount is required, and in turn, a method for improving a packet processing performance is required. Specifically, there is a need in the art for a method and apparatus to perform low-latency and high-speed packet processing in a communication system.

### SUMMARY

The disclosure has been made to address at least the above-mentioned problems and/or disadvantages and to provide at least the advantages described below.

Accordingly, an aspect of the disclosure is to provide a method and device for performing low-latency and high-speed packet processing.

An aspect of the disclosure is to provide a method and apparatus to improve a packet processing capacity of a mobile communication system and reduce a delay time by utilizing an SND.

An aspect of the disclosure is to provide a method and device for identifying a data communication capacity, an encryption processing capacity, and encryption function details of an SND in a mobile communication system.

An aspect of the disclosure is to provide a method and device for performing low-delay and high-speed packet processing through data communication processing in a mobile communication system using an SND.

An aspect of the disclosure is to provide a method and device for performing context update including a security context in an SND in a mobile communication system.

In accordance with an aspect of the disclosure, a method performed by a first device performing packet processing in a mobile communication system includes receiving, from a second device performing packet processing, a packet processing allocation request message requesting packet processing, receiving a packet, determining a packet processing method of the received packet based on the packet processing allocation request message, and performing packet processing of the received packet based on the determined packet processing method.

In accordance with an aspect of the disclosure, a method performed by a second device performing packet processing in a mobile communication system includes identifying a capability of a first device performing packet processing, determining a packet processing method based on the capability of the first device performing the packet processing, and transmitting, to the first device performing packet processing, a packet processing allocation request message requesting packet processing based on the determined packet processing method.

In accordance with an aspect of the disclosure, a first device for performing packet processing in a mobile communication system includes a transceiver configured to transmit and receive signals, and a controller,

wherein the controller is configured to receive a packet processing allocation request message requesting packet processing from a second device performing packet processing, receive a packet, determine a packet processing method of the received packet based on the packet processing allocation request message, and perform packet processing of the received packet based on the determined packet processing method.

In accordance with an aspect of the disclosure, a second device for performing packet processing in a mobile communication system includes a transceiver configured to transmit and receive signals, and a controller, wherein the controller is configured to identify a capability of a first device performing packet processing, determine a packet processing method based on the capability of the first device performing the packet processing, and transmit a packet processing allocation request message requesting packet processing to the first device performing the packet processing based on the determined packet processing method.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates a communication system to which the disclosure may be applied;

FIG. 2 illustrates a protocol structure of a communication system to which the disclosure may be applied;

FIG. 3A illustrates a data packet processing method in a communication system to which the disclosure may be applied;

FIG. 3B illustrates a data packet processing method in a communication system to which the disclosure may be applied;

FIG. 4A illustrates a packet processing procedure in a communication system to which the disclosure may be applied;

FIG. 4B illustrates a packet processing procedure in a communication system to which the disclosure may be applied;

FIG. 5 illustrates the overall flow of performing a packet processing procedure according to an embodiment;

FIG. 6 illustrates a procedure for identifying the capability of a first device performing packet processing according to an embodiment;

FIG. 7 illustrates a procedure for identifying the capability of a device performing packet processing according to an embodiment;

FIG. 8 illustrates a packet processing allocation procedure according to an embodiment;

FIG. 9 illustrates a method of deriving a security key according to an embodiment;

FIG. 10 illustrates a packet processing procedure of a first device performing packet processing according to an embodiment;

FIG. 11A illustrates a packet processing procedure according to an embodiment;

FIG. 11B illustrates a packet processing procedure according to an embodiment;

FIG. 11C illustrates a packet processing procedure according to an embodiment;

FIG. 12 illustrates a security context update procedure according to an embodiment;

FIG. 13 illustrates a packet processing sequence of a first device performing packet processing according to an embodiment;

FIG. 14 illustrates a packet processing sequence of a second device performing packet processing according to an embodiment;

FIG. 15 illustrates an internal structure of a first device performing packet processing according to an embodiment; and

FIG. 16 illustrates an internal structure of a second device performing packet processing according to an embodiment.

### DETAILED DESCRIPTION

Hereinafter, embodiments of the disclosure are described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.
Embodiments of the disclosure enable a constitution of the disclosure to be complete, and are provided to fully inform the scope of the disclosure to those of ordinary skill in the art to which the disclosure pertains.

Hereinafter, some of terms and names defined in the 3rd generation partnership project (3GPP) standards may be used. Terms and names newly defined in a next generation communication system (e.g., 6G, beyond 5G system) to which the disclosure may be applied, or terms and names used in existing communication systems may be used. The use of such terms is not limited by terms and names of the disclosure, and may be equally applied to systems conforming to other standards, and be changed into other forms without departing from the scope of the disclosure. Embodiments of the disclosure may be easily modified and applied to other communication systems.

Singular expressions such as “a” and “the above” not clearly indicating different contents in an embodiment of the disclosure include plural expressions.

Terms including ordinal numbers such as first, second, and the like may be used for describing various components, but the components are not limited by the terms. The terms are used only for the purpose of distinguishing one component from other components. For example, without departing from the scope of the disclosure, a first component may be referred to as the second component, and similarly, a second component may also be referred to as the first component.

The term and/or includes a combination of a plurality of related described items or any one of a plurality of related described items.

Terms used in the disclosure are used for only describing a particular embodiment and are not intended to limit the disclosure. The singular expression includes the plural expression unless the context clearly indicates otherwise. In this specification, it should be understood that terms “include” or “have” and the like are intended to specify that a feature, number, step, operation, component, part, or combination thereof described in the specification exists, but do not exclude in advance the possibility of the presence or addition of one or more other features, numbers, steps, operations, components, parts or combinations thereof.

Terms “associated with” and “associated therewith” and derivatives thereof used in an embodiment of the disclosure indicates include, be included within, interconnect with, contain, be contained within, connect to or with, couple to or with, be communicated with, cooperate with, interleave, juxtapose, be proximate to, be bound to or with, have, have a property of, and the like.

To determine whether a particular condition is satisfied or fulfilled, the expression of more than a specific number or less than a specific number has been used, but this is only a description for representing an example and does not exclude the description of a specific number or more or a specific number or less. A condition described as ‘a specific number or more’ may be replaced by ‘more than a specific number’, a condition described as ‘a specific number or less’ may be replaced by ‘less than a specific number’, and a condition described as ‘a specific number or more and less than a specific number’ may be replaced by ‘more than a specific number and a specific number or less’.

The disclosure describes embodiments using terms used in long term evolution (LTE) and new radio (NR) defined in 3GPP, but this is only an example for description. Embodiments of the disclosure may be easily modified and applied to other communication systems.

In the disclosure, a terminal (or communication terminal) is an entity that communicates with a BS or another terminal, and may be referred to as a node, a UE, a next generation UE (NG UE), a mobile station (MS), a device, or a terminal. The terminal may include at least one of a smart phone, a tablet personal computer (PC), a mobile phone, a video phone, an e-book reader, a desktop PC, a laptop PC, a netbook computer, a personal digital assistant (PDA), a portable multimedia player (PMP), a moving picture experts group layer 3 (MP3) player, a medical device, a camera, or a wearable device. The terminal may include at least one of a television, a digital video disk (DVD) player, an audio player, a refrigerator, an air conditioner, a vacuum cleaner, an oven, a microwave oven, a washing machine, an air purifier, a set-top box, a home automation control panel, a security control panel, a media box, a game console, an electronic dictionary, an electronic key, a camcorder, or an electronic picture frame. The terminal may include at least one of various medical devices (e.g., various portable medical measuring devices (such as blood sugar meter, heart rate meter, blood pressure meter, or body temperature meter), magnetic resonance angiography (MRA), magnetic resonance imaging (MRI), computed tomography (CT), imaging, or ultrasound machine), a navigation device, a global navigation satellite system (GNSS), an event data recorder (EDR), a flight data recorder (FDR), an automobile infotainment device, electronic equipment for ships (e.g., navigation device for ships, gyro compass), avionics, a security device, a head unit for vehicles, an industrial or household robot, a drone, an ATM of a financial institution, a point of sales (POS) of a store, or an Internet of Things device (e.g., light bulb, various sensors, sprinkler device, fire alarm, thermostat, streetlight, toaster, exercise equipment, hot water tank, heater, boiler). The terminal may include various types of multimedia systems capable of performing a communication function. The disclosure is not limited to the above description, and the terminal may be referred to by terms having the same or similar meaning.

The BS is an entity that communicates with a terminal and performs resource allocation of the terminal, and may have various forms and be referred to as a BS, a nodeB (NB), NG radio access network (RAN), an access point (AP), a transmission reception point (TRP), a wireless access unit, a BS controller, or a node on a network. Alternatively, the BS may be referred to as a centralized unit (CU) or a distributed unit (DU) according to function separation. The disclosure is not limited thereto, and the BS may be referred to by a term having the same meaning or a similar meaning.

A radio resource control (RRC) message may be referred to as higher level information, a higher level message, a higher level signal, higher level signaling, or higher layer signaling, and the disclosure is not limited thereto, and the RRC message may be referred to by terms having the same meaning or a similar meaning.

Data may be referred to herein as user data, user plane (UP) data, or application data or may be referred to by terms having the same or similar meaning as that of signals transmitted and received via a data radio bearer (DRB).

The direction of data transmitted from a terminal may be referred to herein as UL, and the direction of data transmitted to the terminal may be referred to as DL. Accordingly, in UL transmission, a transmitter may refer to a terminal, and a receiver may refer to a BS or a specific network entity of a communication system. Alternatively, in DL transmission, a transmitter may refer to a BS or a specific network entity of a communication system, and a receiver may refer to a terminal.

Integrity protection may refer to including integrity protection at the transmitter side and integrity verification at the receiver side. Accordingly, in the disclosure, performing integrity protection on data indicates the same as providing integrity on data, which indicates performing integrity protection on data at the transmitter side and performing integrity verification on data at the receiver side.

Encryption may refer to including encryption at the transmitter side and decryption at the receiver side. Accordingly, in the disclosure, performing encryption on data indicates the same as providing confidentiality on data, which indicates performing encryption on data at the transmitter side and decryption at the receiver side.

Providing security to data indicates the same as applying security to data, which indicates performing a series of procedures for strengthening the security of data. For example, providing security to data indicates performing encryption for providing confidentiality to the data or performing integrity protection for providing integrity to the data.

Hereinafter, UP security procedures that provide security to data (user data or application data) transmitted and received in an UP DRB are mainly described, but the disclosure is not limited thereto. It is obvious to those skilled in the art that the disclosure may be applied even to various security procedures.

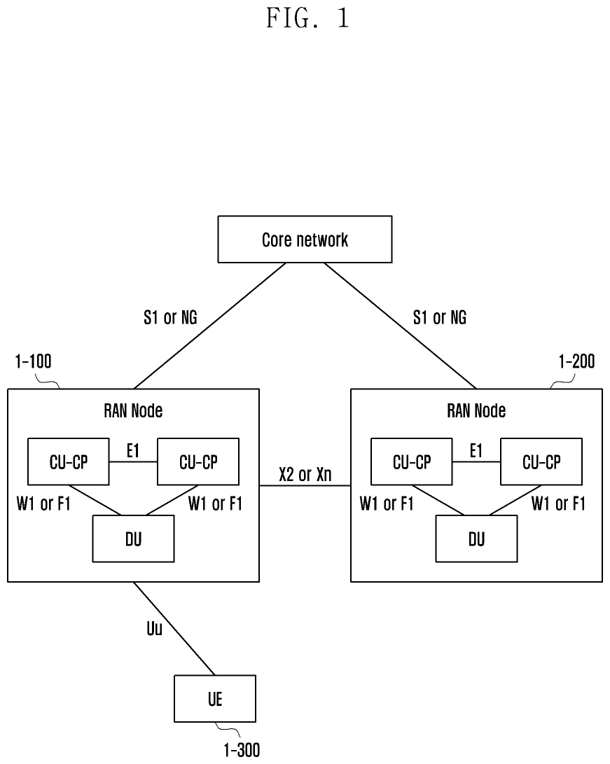

FIG. 1 illustrates a communication system to which the disclosure may be applied.

Referring to FIG. 1, RAN nodes 1-100 and 1-200 indicates LTE evolved node B (eNodeB), NR next generation node B (gNodeB (gNB)), a BS of a next generation mobile communication system, or a network node performing the same function as or similar functions thereto connected to a mobile communication core network (CN) such as an evolved packet core (EPC) or a 5G CN (5GC). The RAN nodes 1-100 and 1-200 may be functionally separated into a CU and a DU, and the CU may be functionally separated again into a CU-control plane (CP) and a CU-UP. A UE 1-300 is connected to the RAN node 1-100.

In the disclosure, one RAN node may be composed of one or more CU-CUPs, one or more CU-UPs, and one or more DUs. One RAN node may be composed of a CU-CP, a CU-UP, and a DU. For example, one RAN node may be composed of a CU and a DU in which a CU-CP and a CU-UP are implemented together. Alternatively, one RAN node may be constituted in the form of an integrated BS in which a CU-CP, a CU-UP, and a DU are implemented together. A constitution of the RAN node as described above is only an example, and the disclosure is not limited thereto. One RAN node may be constituted with any other combination other than the examples described above.

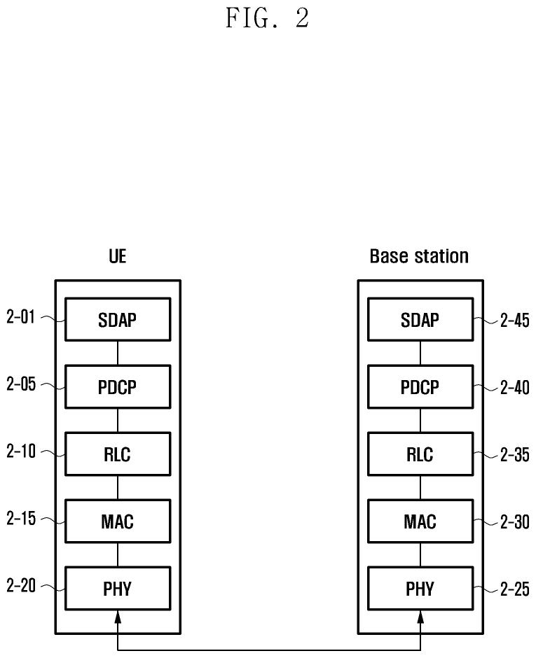

The CU and the DU may each support functions of the BS. For example, the CU may support functions of an RRC layer or a packet data convergence protocol (PDCP) layer, and the DU may support functions of a radio link control (RLC) layer, a medium access control (MAC) layer, a physical (PHY) layer, or an RF layer. The CU and the DU may be connected to each other through an interface between internal functions of the BS, such as a W1 interface or an F1 interface. Specific details regarding functions of each layer supported by the CU and the DU will be described later with reference to FIG. 2.

The CU may be divided into a CU-CP and a CU-UP. In this case, for example, the CU-CP may support a function of an RRC layer or a PDCP (for RRC) layer, and the CU-UP may support a function of PDCH (for user data transmission) layer. The CU-CP and the CU-UP may be connected through an interface between internal functions of the BS, such as an E1 interface.

The RAN node or the BS may be implemented into an integrated structure or a separated structure, and connection may be possible between integrated structure BSs, between separated BSs, and between integrated structure BSs and separated structure BSs. The RAN nodes may be connected through an inter-BS interface such as an X2 interface or an Xn interface. The RAN node and the CN may be connected through an interface between the BS and the CN, such as an S1 interface or an NG interface.

The CN may include various network entities (e.g., network entities performing other specific functions, such as a UP function (UPF), a session management function (SMF), an access and mobility function (AMF), a network exposure function (NEF), or an application function (AF)).

The UPF is a network function (NF) responsible for a UP in a CN. The UPF may perform a function of mapping packets of an Internet protocol (IP) flow to a specific quality of service (QoS) flow belonging to a specific protocol data unit (PDU) session based on information (e.g., at least one of a packet detection rule (PDR), a forwarding action rule (FAR), a QoS enforcement rule (QER), or a usage reporting rule (URR)) received from one (e.g., SMF) of CP NFs.

The SMF is an NF responsible for a CP in the CN. The SMF may transmit information (e.g., at least one of QoS flow indicator (QFI), QoS profile, PDR, FAR, QER, or URR) necessary for guaranteeing a QoS to the UPF and the BS. The SMF may determine the UP security policy on whether to activate UP confidentiality or UP integrity for all DRBs belonging to the corresponding PDU session during a PDU session establishment procedure and transmit the UP security policy to the BS through the AMF.

The above-described communication system is only an example, and the disclosure may be applied and implemented in various communication systems.

FIG. 2 illustrates a protocol structure of a communication system to which the disclosure may be applied.

Referring to FIG. 2, the protocol structure of the communication system may include service data adaptation protocols (SDAPs) 2-01 and 2-45, PDCPs 2-05 and 2-40, RLCs 2-10 and 2-35, MACs 2-15 and 2-30, and PHYs 2-20 and 2-25 in the UE and the BS, respectively.

Main functions of the SDAP 2-01 and 2-45 may include some of the following functions.
Transfer of UP data
Mapping between a QoS flow and a DRB for both DL and UL
Marking QoS flow ID in both DL and UL packets
Reflective QoS flow to DRB mapping for the UL SDAP PDUs.

For the SDAP layer (or SDAP layer device), the UE may be configured by an RRC message for whether to use a header of the SDAP layer device for each PDCP layer, for each bearer, or for each logical channel, or whether to use a function of the SDAP layer device. When the SDAP header is configured, the UE may instruct to update or reconfigure mapping information on UL and DL QoS flows and data bearers with a 1-bit indicator for reflecting a non-access stratum (NAS) QoS (NAS reflective QoS) of the SDAP header and a 1-bit indicator for reflecting an access stratum (AS) QoS (AS reflective QoS) of the SDAP header. The SDAP header may include QoS flow ID information indicating a QoS. The QoS information may be used as data processing priorities, scheduling information, and the like for supporting smooth services.

Main functions of the PDCPs 2-05 and 2-40 may include some of the following functions.
Robust header compression and decompression
Transfer of user data
-n-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in UL.

Herein, reordering of the PDCP layer (or PDCH layer device) indicates a function of sequentially reordering PDCP PDUs received from a lower layer based on a PDCP sequence number (SN). The reordering of the PDCP layer may include delivering data to a higher layer in the rearranged order. Alternatively, the reordering of the PDCP layer may include directly delivering data without considering the order. The reordering of the PDCP layer may include rearranging the order and recording lost PDCP PDUs, a function of reporting a status of lost PDCP PDUs to the transmitting side, and a function of requesting retransmission of lost PDCP PDUs.

Main functions of the RLCs 2-10 and 2-35 may include some of the following functions.
Transfer of upper layer PDUs
In-sequence delivery of upper layer PDUs
Out-of-sequence delivery of upper layer PDUs
Error correction through automatic repeat request (ARQ)
Concatenation, segmentation and reassembly of RLC SDUs Re-segmentation of RLC data PDUs
Reordering of RLC data PDUs
Duplicate detection
Protocol error detection
RLC SDU discard
RLC re-establishment

Herein, in-sequence delivery of the RLC layer (or RLC layer device) indicates sequentially delivering RLC SDUs received from a lower layer to an upper layer. When one RLC SDU is originally divided into multiple RLC SDUs and received, the in-sequence delivery of the RLC layer may include reassembling and delivering the multiple RLC SDUs.

The in-sequence delivery of the RLC layer may include reordering received RLC PDUs based on the RLC SN or the PDCP SN. The in-sequence delivery of the RLC layer may include reordering the order to record lost RLC PDUs. The in-sequence delivery of the RLC layer may include reporting a status of lost RLC PDUs to the transmitter, and requesting retransmission of lost RLC PDUs.

The in-sequence delivery of the RLC layer may include sequentially delivering only RLC SDUs before a lost RLC SDU to the upper layer when there is a lost RLC SDU.

The in-sequence delivery of the RLC layer may include sequentially delivering all RLC SDUs received before a predetermined timer starts to the upper layer if a predetermined timer has expired, even if there is a lost RLC SDU.

The in-sequence delivery of the RLC layer may include sequentially delivering all RLC SDUs received up to the present time, to the upper layer, if a predetermined timer has expired, even if there is a lost RLC SDU.

The RLC layer may process RLC PDUs in the order in which they are received (out-of sequence delivery) and deliver the RLC PDUs to the NR PDCP layer.

When the RLC layer receives a segment, the RLC layer may receive segments that are stored in a buffer or will be received later, reconstitute the segments into a complete RLC PDU, and then deliver the RLC PDU to the PDCP layer.

The RLC layer may not include a concatenation function. Alternatively, the concatenation function may be performed in the MAC layer, or the concatenation function may be replaced by a multiplexing function of the MAC layer.

Herein, out-of-sequence delivery of the RLC layer indicates a function of directly delivering RLC SDUs received from a lower layer to an upper layer regardless of the order. The out-of-sequence delivery of the RLC layer may include reassembling and delivering multiple RLC SDUs when an RLC SDU is originally divided and received into multiple RLC SDUs. The out-of-sequence delivery of the RLC layer may include storing RLC SNs or PDCP SNs of received RLC PDUs and arranging the order thereof to record lost RLC PDUs.

The MACs 2-15 and 2-30 may be connected to several NR RLC layer devices constituted in one UE, and main functions of the NR MAC may include some of the following functions.
Mapping between logical channels and transport channels
Multiplexing/demultiplexing of MAC SDUs
Scheduling information reporting
Error correction through hybrid automatic repeat request (HARQ)
Priority handling between logical channels of one UE
Priority handling between UEs by means of dynamic scheduling
Multimedia broadcast multicast service (MBMS) identification
Transport format selection
Padding

PHY layers 2-20 and 2-25 may perform operations of channel-coding and modulating higher layer data, making the higher layer data into OFDM symbols and transmitting the OFDM symbols through a radio channel, or demodulating OFDM symbols received through a radio channel, channel-decoding the OFDM symbols, and delivering the OFDM symbols to a higher layer.

Functions or names of each layer of the protocol structure described with reference to FIG. 2 may be changed.

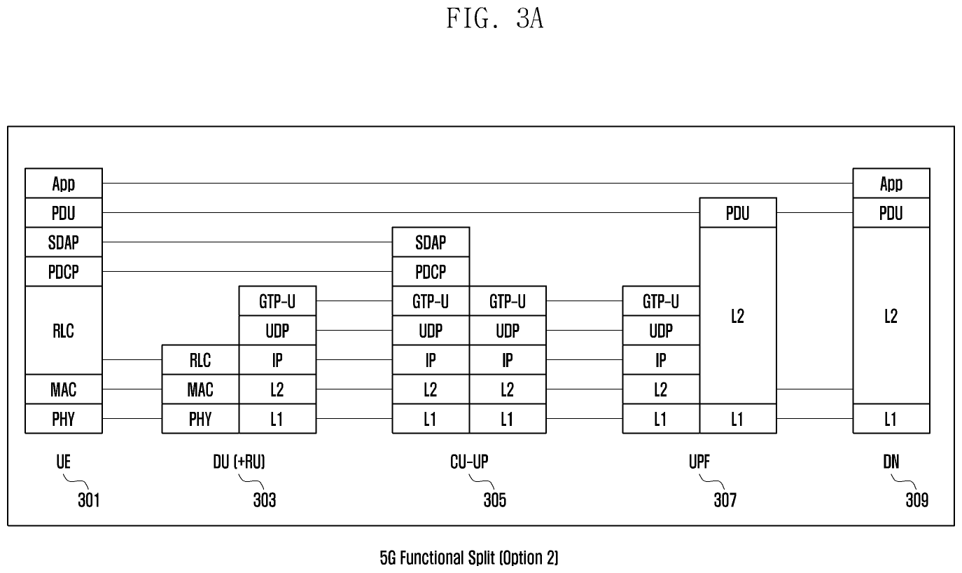

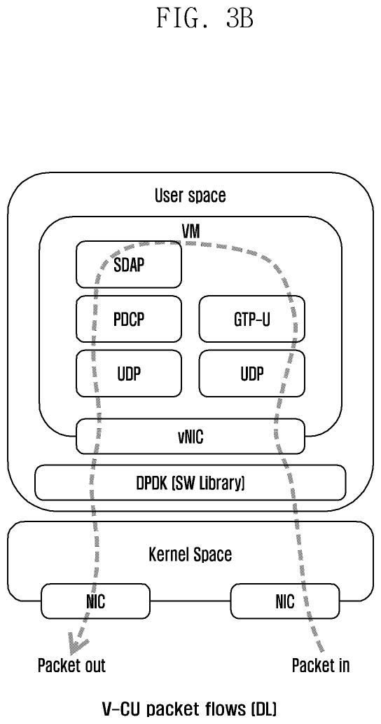

FIGS. 3A and 3B are diagrams illustrating a data packet processing method in a communication system to which the disclosure may be applied.

A mobile communication system is located between a data network (DN) and a UE and may continuously provide telephone and data services even when the UE is moving. In 5G, to continuously provide telephone and data services even when the UE is moving, a CP and a UP are distinguished.

In the CP, a link with the UE may be formed, and a data service function may be controlled. In the UP, high-quality communication and data services may be provided to the UE.

In 5G, functions of BSs are subdivided, and are split into a CU-UP and a DU to provide processing functions.

Referring to FIG. 3A, a protocol stack of a UPF 307 corresponding to a CN is illustrated to provide data services to a UE 301, and a CU-UP 305 and a DU 303 corresponding to a BS are illustrated.

When a DN 309 transmits data (which may be used interchangeably with packet or data packet), each data may be transmitted to the UE 301 through at least one layer. A process of transmitting data will be specifically described with reference to FIG. 3B.

Some layers among layers through which data passes may provide security for the data. For example, when data is application data, the data may be protected by application security such as transport layer security (TLS) in an application layer. Thereafter, the PDCP layer of the UE and the BS may perform integrity protection or encryption on the data. In this case, even if the data is already encrypted, encryption may be performed redundantly on the data in the PDCP layer.

A protocol structure illustrated in FIG. 3A is only an example for convenience of description, and the disclosure is not limited thereto. Names and functions of each layer in the protocol structure illustrated in FIG. 3A may be changed, and an interface between the CU and the DU may also be changed. The disclosure may be applied to a protocol structure that does not consider function separation of the CU and the DU.

FIG. 3B illustrates the flow of packets in a communication system to which the disclosure may be applied.

The BS may directly transmit data (term “packet” or “data packet” may be used interchangeably) to the UE. To reduce the installation cost and operating cost of the BS, an operator may offload BS SW on a virtualized platform to provide a mobile communication service. Hereinafter, FIG. 3B illustrates the flow of DL packets in a virtualized CU-UP BS when the UE downloads data.

A virtualized platform (e.g., virtual-CU (V-CU)) may be composed of several layers. There is a server itself, and there is a virtualization supervisor that operates the server. A SW-based mobile communication BS operates in a VM form in a virtualization space allocated by the virtualization supervisor. Therefore, an incoming (received) packet passes through a virtualization supervisor area and enters as BS SW, and when the packet goes out, it also passes through the virtualized area.

More specifically, a packet may be entered (transmitted) into a V-CU through a network interface card (NIC). Thereafter, the incoming (transmitted) packet is entered into BS SW within a VM through a virtualized virtual NIC (vNIC) via a kernel space of the virtualization platform. Within the VM, there exist several protocol stacks of BSs of the mobile communication system, and appropriate packet processing is performed at each layer. Thereafter, the BS transmits the processed packet to a DU through the virtualization platform.

In the protocol structure, each layer in which data is transmitted may add information related to the data (e.g., a header or additional information of the corresponding layer) to the data and deliver the data to a lower layer. For example, the SDAP layer may add an SDAP header to a packet received from the PDU layer and deliver the packet to the PDCP layer, which is the lower layer. Thereafter, the PDCP layer may perform integrity protection or encryption on the packet received from the SDAP layer and deliver the packet in which the PDCP header is added to RLC layer.

In performing integrity protection on the packet at the PDCP layer, information (e.g., MAC-I) for integrity protection of the packet is generated and added (or inserted) to the next location of data in the packet. In performing encryption for providing confidentiality at the PDCP layer, a portion of the packet excluding the SDAP header is encrypted.

Data transmission and reception in a communication system to which the disclosure may be applied may be performed through numerous layers according to a protocol structure as described above, and some PDCP layers may provide security for data.

FIG. 3B illustrates a flow of DL packets in a virtualized CU-UP BS, but the disclosure is not limited thereto and may be applied to a flow of UL packets or to a BS that does not consider function separation of a CU and a DU.

In FIGS. 3A and 3B, the BS may perform packet processing through numerous layers within a virtualized platform.

To solve the problems described above with respect to this processing, disclosed herein is a method of performing low-latency and high-speed packet processing using an SND. However, the scope of the disclosure is not limited to being performed in a virtualized environment, and may be applied even to a general server environment.

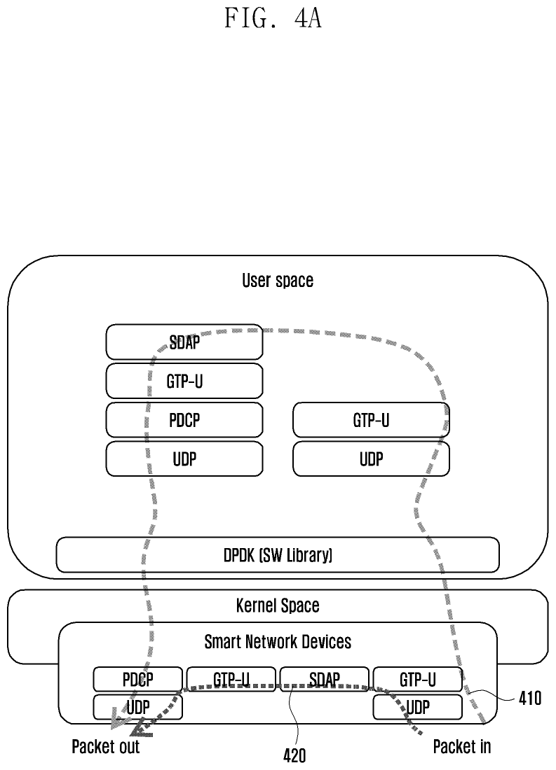

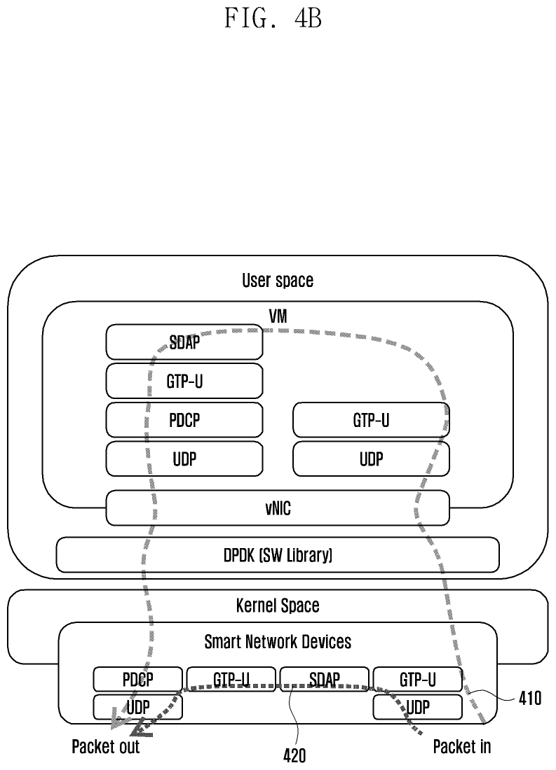

FIG. 4A illustrates a packet processing procedure in a general server environment to which the disclosure may be applied. FIG. 4B illustrates a packet processing procedure in a virtualized environment to which the disclosure may be applied. Prior to describing FIGS. 4A and 4B, meanings of terms used throughout the specification may be as follows.

An SND refers to a network device that has special functions that may perform calculations in addition to established functions. In addition to the existing packet processing function, the SND has logic that may perform special calculations. Therefore, by utilizing the logic present in the SND, a packet processing performance may be improved or calculations for the desired purpose may be performed.

The SND may include a smart NIC, a programmable switch application specific integrated circuit (ASIC), and a net field programmable gate array (NetFPGA).

A virtualized platform (or virtualized computer) may improve a performance thereof by utilizing the SND. More specifically, the virtualized computer may offload some of network operations by utilizing the SND and improve network operations without intervention of the CPU. Offloading indicates that a network device performs some of functions of a host device (e.g., CPU) to improve a performance of the host device. The SND is programmable regardless of specific protocols. Therefore, network operations may be improved by configuring a program required to perform a specific calculation (e.g., packet processing or security calculation).

In this manner, by performing a specific calculation according to the purpose, the SND may reduce a delay time by approximately 2× to 20×, and enable high-speed packet processing.

Hereinafter, terms first device performing packet processing and second device performing packet processing will be used.

The first device performing packet processing performs (or offloads) some functions (e.g., packet processing or security calculation) of the second device performing packet processing, and may include an SND.

The second device performing packet processing allocates (or offloads) some functions (e.g., packet processing or security calculation) thereof so that the first device performing packet processing performs some functions of the second device. The second device performing packet processing may include any one of a BS, a VM, or a V-CU in which SW is offloaded onto a virtualized platform. The second device performing packet processing may perform some functions (e.g., packet processing or security calculation) thereof through a plurality of first devices performing packet processing.

Both the first device performing a packet processing function and the second device performing a packet processing function are not limited to physical equipment. Likewise, specific examples of the first device performing the packet processing and the second device performing the packet processing are provided to explain the disclosure, and the scope of the disclosure is not limited thereto. FIG. 4A illustrates a packet processing procedure using the first device performing a packet processing function in a general server environment.

Referring to 410, when a new packet is entered through the first device (e.g., NIC) performing packet processing in a general server environment, the new packet may be transmitted to the second device (e.g., user space) performing packet processing through a kernel space. Thereafter, packet processing is performed in user datagram protocol (UDP), GPRS tunneling protocol (GTP)-UP (GTP-U), SDAP, PDCP, and UDP layers of the second device performing the packet processing function. Thereafter, the packet may be transmitted to the UE through the kernel space and the NIC.

At 420, in a general server environment, when a new packet is entered, the first device performing packet processing may directly perform packet processing without transmitting the new packet to the second device performing a packet processing function. That is, the new packet may be transmitted directly to the UE after performing a packet processing procedure in the first device without transmitting to the second device through the kernel space.

Alternatively, in a general server environment, the first device performing packet processing may perform only some packet processing procedures for a newly incoming packet.

FIG. 4B illustrates a packet processing procedure using a first device performing a packet processing function in a virtualization environment.

FIG. 4B assumes that a mobile communication system operates in a cloud environment. Therefore, a VM of FIG. 4B means mobile communication system SW operating in a cloud environment, and the SND may be understood as being installed in the cloud system. However, this is only for understanding the disclosure, and the scope of the disclosure is not limited to a virtualized cloud environment. The disclosure applies even when general mobile communication system SW is used instead of the VM.

FIG. 4B assumes that the SND is installed in a virtualized cloud environment. However, the SND does not necessarily indicate only a virtualized cloud environment. The SND may be installed in a server in which general mobile communication system SW operates. The SND may be constituted to be logically or physically separated.

FIG. 4B illustrates the flow based on download traffic transmitting to the UE in a mobile communication system. However, the scope of the disclosure is not limited thereto, and the disclosure may be applied equally to upload traffic.

Although FIG. 4B illustrates only one second device, i.e., a VM, performing packet processing and one first device, i.e., an SND, performing packet processing, the scope of the disclosure is not limited thereto, and the second device performing packet processing may perform a packet processing procedure through a plurality of first devices performing packet processing.

The flow indicated at 410 is a packet processing method by the second device performing packet processing. More specifically, in the second device performing packet processing, when a new packet is entered through the smart NIC, the new packet is entered (or input) into a vNIC through a kernel space and data plane development kit (DPDK). The second device performing the packet processing function performs packet processing in, SDAP, GTP-U, PDCP, and UDP layers. Thereafter, the packet may be transmitted to the UE through the vNIC, DPDK, and kernel space.

The flow indicated at 420 illustrates a packet processing method by the first device performing packet processing. More specifically, when a new packet is entered, the first device performing packet processing may directly perform packet processing on the new packet without transmitting the new packet to the second device performing the packet processing function. That is, the new packet may be directly transmitted to the UE after performing a packet processing procedure performed in the UDP, GTP-U, SDAP, GTP-U, PDCP, and UDP layers of the first device without transmitting to the second device through the kernel space, DPDK, and vNIC.

Disclosed is a method and device for identifying a performance and/or function of an SND in a mobile communication system for low-latency and high-speed packet processing, and allocating and/or updating a data communication session. In detail, the method includes identify a performance and function within the SND, i.e., identify a data communication capacity, an encryption processing capacity, and encryption function details, allocate data communication sessions within the SND and perform high-speed packet processing, and update a context in the SND: When a context including a security context is updated during high-speed packet processing, update is also performed in the SND.

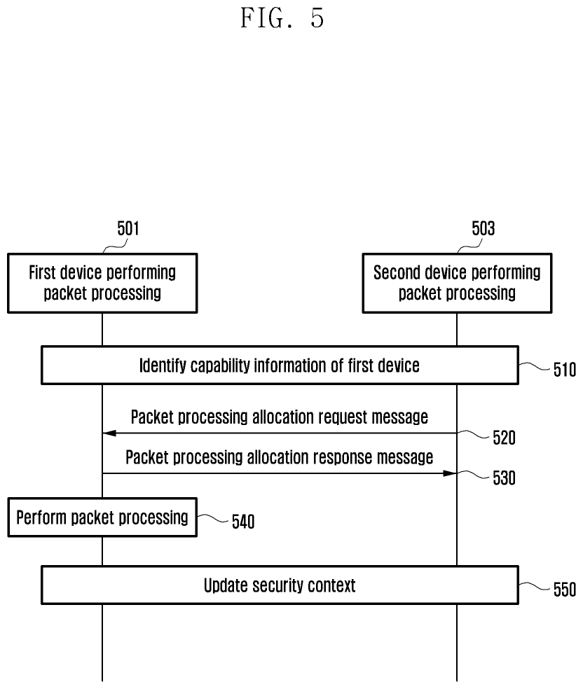

FIG. 5 illustrates the overall flow of performing a packet processing procedure according to an embodiment.

Referring to FIG. 5, a second device 503 performing packet processing may allocate packet processing to a first device 501 performing packet processing. The first device performing packet processing is not limited to physical equipment, is a device that receives a request for packet processing allocation from the second device performing packet processing, and may include an SND. The second device performing packet processing is also not limited to physical equipment, and may include any one of a BS, a VM, or a V-CU in which SW is offloaded onto a virtualized platform. Low-latency and high-speed packet processing procedures may include the following procedures.
1. The second device performing packet processing allocates packet processing of specific data communication to the first device performing packet processing.
2. The first device performing packet processing performs low-latency and high-speed packet processing for allocated data communication.
3. The second device performing packet processing and the first device performing packet processing configure and update packet information through tables, and the like for each layer to manage packet processing and flow.

Referring to FIG. 5, in step 510, the second device (e.g., which may include a VM) 503 performing packet processing may identify capability information of the first device (e.g., which may include an SND) 501 performing packet processing.

For example, the second device 503 performing packet processing may transmit a first device capability request message to identify capability information of the first device 501 performing packet processing. Upon receiving the first device capability request message, the first device 501 performing packet processing may include capability information thereof and transmit a first device capability response message.

The capability information of the first device 501 performing the packet processing may include one or more of capacity information, function information, and information on a current situation related to packet processing of the first device.

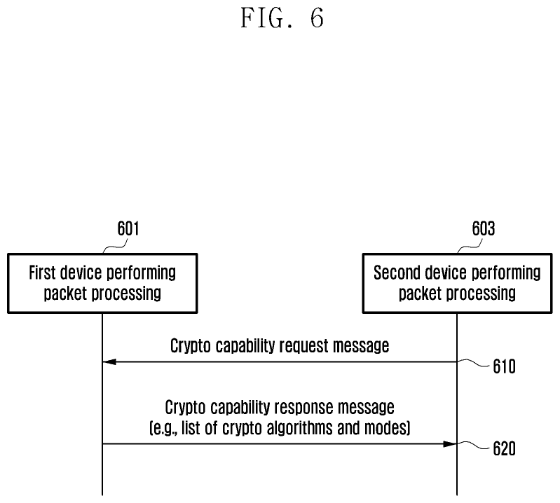

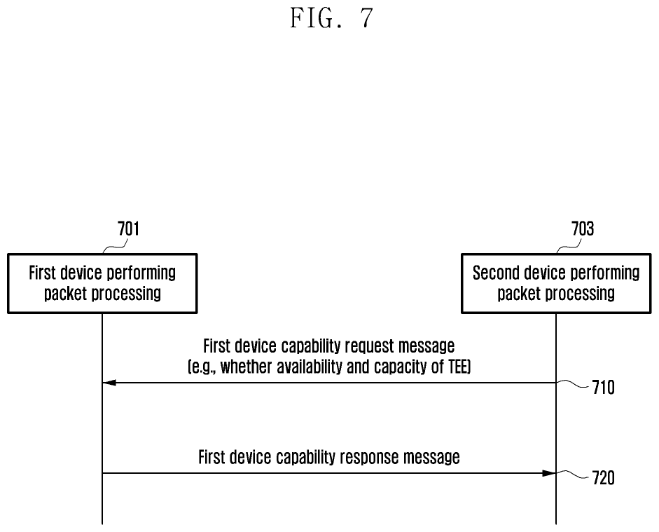

Ab embodiment of identifying capability information of the first device will be described below with reference to FIGS. 6 and 7.

In step 520, the second device 503 performing the packet processing may transmit a packet processing allocation request message to the first device 501 performing the packet processing. More specifically, the packet processing allocation request message may include a content requesting that the first device perform (process, or handle) processing (or handling) of some packets (or specific flows) in which the second device was scheduled to process.

In step 530, the first device 501 performing the packet processing may transmit a packet processing allocation response message to the second device 503 performing the packet processing. More specifically, the first device 501 may transmit a packet processing allocation response message in response to a request from the second device 503.

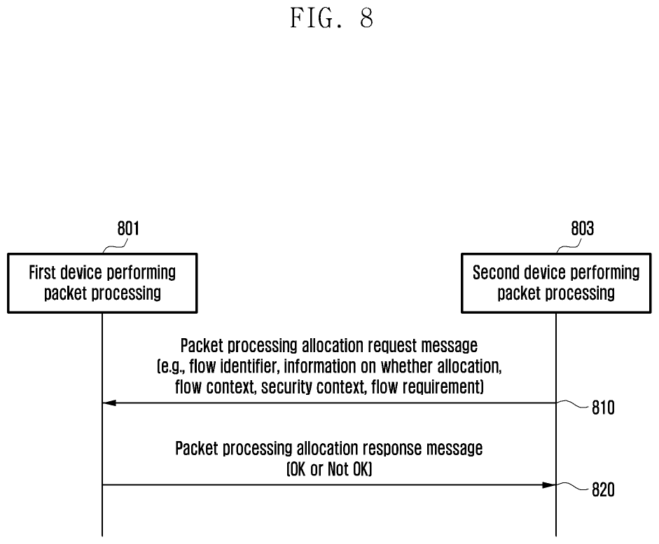

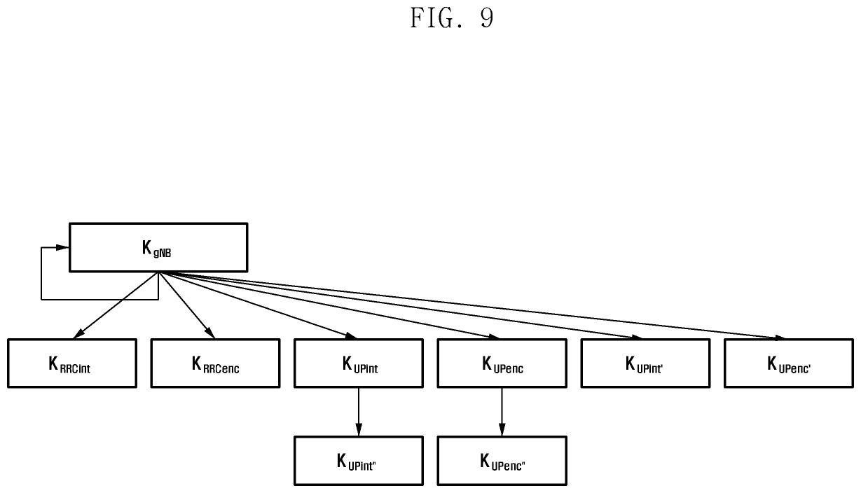

A specific embodiment in which the second device transmits a packet processing allocation request message and in which the first device transmits a packet processing allocation response message will be specifically described with reference to FIGS. 8 and 9.

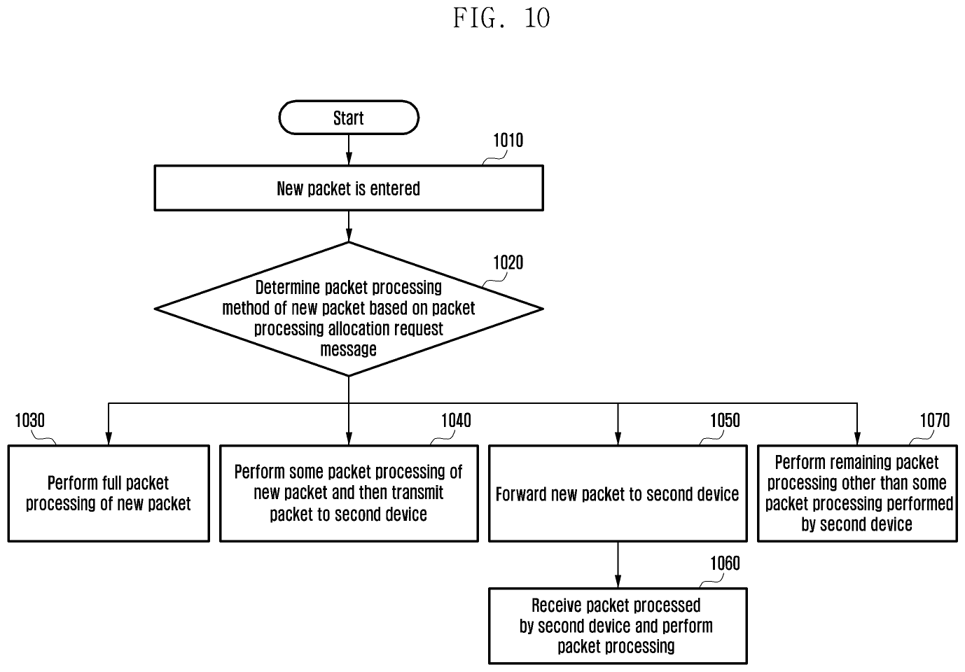

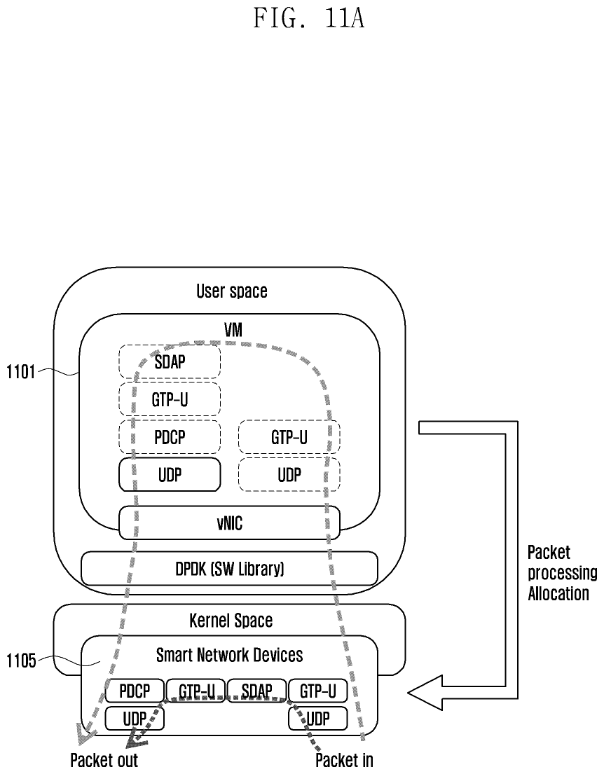

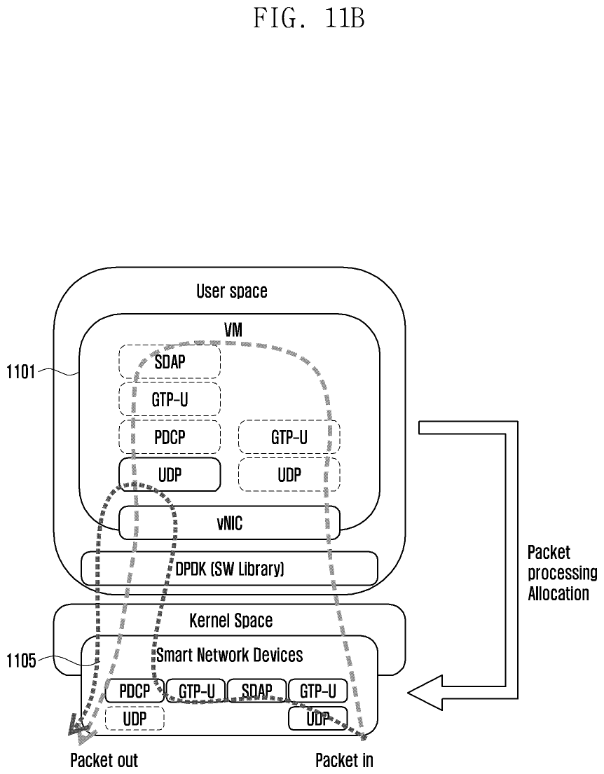

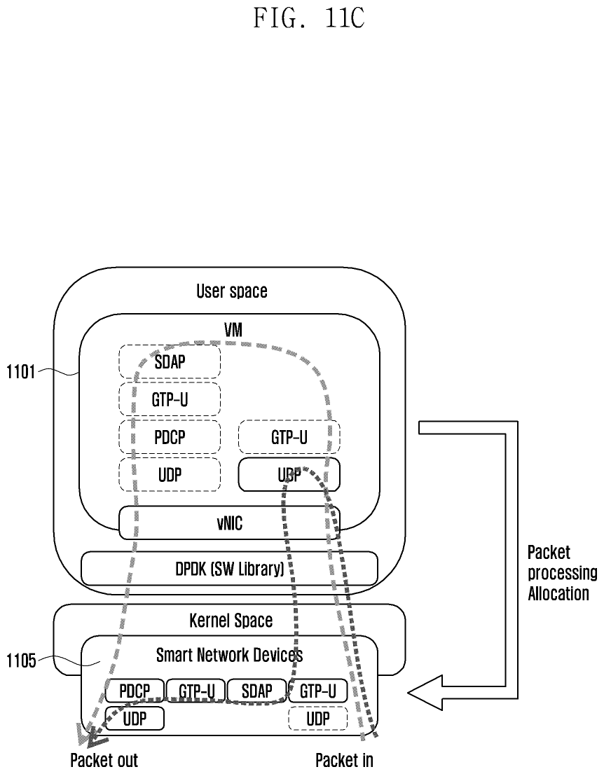

In step 540, the first device 501 performing the packet processing may transmit the packet processing allocation response message (or responding to the second device) and then perform packet processing on behalf of the second device 503 (or may process the packet). More specifically, the first device 501 performing the packet processing may perform low-latency and high-speed packet processing. An embodiment in which the first device 501 performing the packet processing performs packet processing will be described later with reference to FIGS. 10 and 11A to 11C.

In step 550, the second device 503 performing the packet processing and the first device 501 performing the packet processing may update a security context when the security context is updated during packet processing.

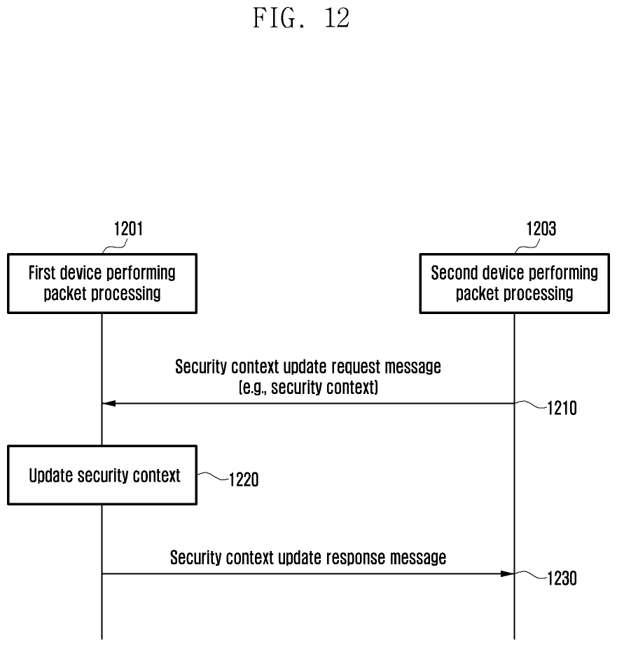

More specifically, the second device 503 may transmit a security context update request message to the first device 501. In response thereto, the first device 501 may update the security context and then transmit a security context update response message. Initiating the security context will be described with reference to FIG. 12.

In the above procedure, a name of the message and information that may be included in the message may be changed.

FIG. 6 illustrates a procedure for identifying the capability of a first device performing packet processing according to an embodiment.

Referring to FIG. 6, a second device 603 performing packet processing may identify the capability of a first device 601 performing packet processing (SND algorithm capability negotiation). The first device performing packet processing is not limited to physical equipment, is a device that receives a request for packet processing allocation from the second device performing packet processing, and may include an SND. The second device performing packet processing is also not limited to physical equipment, and may include any one of a BS, a VM, or a V-CU in which SW is offloaded onto a virtualized platform.

In step 610, the second device (e.g., which may include a VM) 603 performing packet processing may transmit a crypto capability request message (e.g., crypto capability request) to the first device (e.g., which may include an SND) 601 performing packet processing.

More specifically, the second device 603 performing packet processing may inquire the capability on whether a specific encryption algorithm and mode are available or whether a capacity is possible to the first device 601 performing packet processing. The detailed encryption algorithm and mode may be as follows. However, the encryption algorithm and mode described below are only an embodiment of the disclosure, and the scope of the disclosure is not limited to the following algorithm and mode (algorithm-mode).
1. AES (Advanced Encryption Standard)
ECB (Electronic Code Block)
CBC (Cipher Block Chaining)
PCBC (Propagating CBC)
CFB (Cipher FeedBack)
OFB (Output Feedback)
CTR (countTeR)
CCM (Counter with CBC-MAC),
GCM (Galois/Counter Mode), etc.
2. Snow 3G
EEA (EPS Encryption Algorithm)
EIA (EPS Integrity Algorithm), etc.
3. ZUC
EE EIA
-GXM
MUR, etc.

In step 620, the first device 601 performing packet processing may transmit a crypto capability response message to the second device 603 performing packet processing.

More specifically, the first device 601 may identify available encryption algorithm and mode thereof and then transmit a crypto capability response message including available encryption algorithm and mode. The crypto capability response message may include information on the capacity of the first device 601.

FIG. 7 illustrates a procedure for identifying the capability of a device performing packet processing according to an embodiment.

Referring to FIG. 7, a second device 703 performing packet processing may identify a trusted execution environment (TEE) support capability of a first device 701 performing packet processing (TEE availability and capability). The first device performing packet processing is not limited to physical equipment, is a device that receives a packet processing allocation request from the second device performing packet processing, and may include an SND. The second device performing packet processing is also not limited to physical equipment, and may include any one of a BS, a VM, or a V-CU in which SW is offloaded onto a virtualized platform.

In step 710, the second device (e.g., which may include a VM) 703 performing packet processing may transmit a first device capability request message to the first device (e.g., which may include an SND) 701 performing packet processing. More specifically, the second device 703 performing packet processing may inquire about the availability and capacity of a TEE for trustworthiness of the calculation to the first device 701 performing packet processing. The availability and capacity of the TEE are calculation resource capacity, traffic processing capacity, number of processing sessions, supported encryption algorithms and capacity, and the like, but the disclosure is not limited thereto.

In step 720, the first device 701 performing packet processing may transmit a first device capability response message to the second device 703 performing the packet processing.

More specifically, in response to the first device capability request message, the first device 701 may identify whether TEE availability and capacity thereof, and then transmit a first device capability response message including information on whether TEE availability and capacity of the first device.

FIG. 8 illustrates a packet processing allocation procedure according to an embodiment.

Referring to FIG. 8, a second device 803 performing packet processing may allocate some packet processing functions to a first device 801 performing packet processing (packet processing allocation). The first device performing packet processing is not limited to physical equipment, is a device that receives a packet processing allocation request from the second device performing packet processing, and may include an SND. The second device performing packet processing is also not limited to physical equipment, and may include any one of a BS, a VM, or a V-CU in which SW is offloaded onto a virtualized platform.

The second device (e.g., may include a VM) 803 performing packet processing may request packet processing to the first device (e.g., may include a VM) 801 performing packet processing considering the following situation.

Capacity and status of the second device performing packet processing: packet and encryption processing capacity, capability, utilization amount, packet throughput, and the like

Capacity and status of the first device performing packet processing: packet and encryption processing capacity, capability, utilization amount, packet throughput, and the like

### Flow Requirements: QoS, Delay Time, Packet Throughput

In step 810, the second device 803 performing the packet processing may transmit a packet processing allocation request message to the first device 801 performing the packet processing.

More specifically, the packet processing allocation request message may include at least one of a flow identifier, an allocation or allocation exclusion, a flow context (+security context), or flow requirements.

The packet processing allocation request message may include reference information for distinguishing traffic (which may be used interchangeably with terms “packet”, “data”, or “data packet”). For example, the second device 803 performing the packet processing and the first device 801 performing the packet processing may classify traffic (which may be used interchangeably with terms “flow” or “packet”) based on a context and forward traffic for the next packet processing (Context based Traffic Classification). The context may be as follows, and all other information for classifying traffic may be utilized.

### UE Information: UE Context

Flow information: PDU session information, SDAP information, PDCP information, transmission control protocol (TCP)/UDP/IP information, quick UDP Internet connection (QUIC) information, etc.

### Security Information: gNB Security Context, IPsec Information

The security context included in the packet processing allocation request message may include K_{gNB}, K_{Upint}, and K_{Upenc}, which are keys for encrypting traffic. Alternatively, the second device 803 performing the packet processing may generate a new key upon high-speed packet processing, and specific details of generating a new key will be specifically described with reference to FIG. 9.

In step 820, the first device 801 performing the packet processing may transmit a packet processing allocation response message to the second device 803 performing the packet processing. More specifically, the first device 801 may determine the requirement of the second device 803 and then transmit a packet processing allocation response message including OK or Not OK. Additionally, when the first device 801 transmits Not Ok, the first device 801 may transmit a message including a reason for failure such as no remaining capacity or failure to satisfy the flow requirement.

FIG. 9 illustrates a method of deriving a security key according to an embodiment.

Referring to FIG. 9, a procedure for deriving a security key used between a first device performing packet processing and a second device performing packet processing is illustrated. The first device performing packet processing is not limited to physical equipment, is a device that receives a packet processing allocation request from the second device performing packet processing, and may include an SND. The second device performing packet processing is also not limited to physical equipment, and may include any one of a BS, a VM, or a V-CU in which SW is offloaded onto a virtualized platform.

The first device performing the packet processing and the second device performing the packet processing correspond to separate devices. It may be advantageous from a security viewpoint to use different security keys between the two different devices. Therefore, the second device performing the packet processing may derive and use a new security key in addition to the existing security keys K_{gNB}, K_{UPint}, and K_{UPenc.}

A new security key may be generated and used in various manners. For example, as an embodiment of various methods, the second device performing packet processing may derive new security keys K_{UPint′} and K_{UPenc′} from K_{gNB}. Alternatively, the second device performing packet processing may derive new security keys K_{UPint″} and K_{UPenc″} from the previously used K_{UPint} and K_{UPenc.}

FIG. 10 illustrates a packet processing sequence of a first device performing packet processing according to an embodiment.

The first device performing packet processing is not limited to physical equipment, is a device that receives a packet processing allocation request from the second device performing packet processing, and may include an SND. The second device performing packet processing is also not limited to physical equipment, and may include any one of a BS, a VM, or a V-CU in which SW is offloaded onto a virtualized platform.

As described above, the second device (e.g., which may include a VM) performing packet processing may transmit a packet processing allocation request message to the first device (e.g., an SND) performing packet processing. The packet processing allocation request message may include reference information for distinguishing incoming traffic (which may be used interchangeably with terms flow, data, data packet, or packet).

In step 1010, a new packet may be entered into the first device performing the packet processing.

In step 1020, the first device performing packet processing may determine a packet processing method of the new packet based on a packet processing allocation request message received from the second device performing packet processing.

The packet processing method of a new packet may be as follows.

### (1) The First Device Performs Full Packet Processing

The second device performing packet processing may determine to enable the first device performing packet processing to process the entire specific flow when a low-latency service is required or that a processing capacity of the second device performing packet processing is saturated.

### (2) After the First Device Performs Partial Processing of the Packet, the Second Device Performs the Remaining Processing

When the second device performing packet processing wants to efficiently use a memory of the first device performing packet processing, the second device may determine to enable the first device to perform processing on a new packet only up to a partial layer and then to enable the second device to perform the remaining processing.

If the first device performs packet processing only up to the PDCP layer for the new packet and transmits (or transfers) the packet to the second device, a packet queue transmitted to the UE (or outgoing from the BS) is processed by the second device. In this case, because the first device does not need to store UDP-related packets, the memory of the first device may be utilized more efficiently.

### (3) The First Device Forwards the Packet to the Second Device

When the second device wants to reduce a calculation amount of the first device performing packet processing and to efficiently utilize the memory of the first device, the second device performing the packet processing may determine to enable the first device directly to forward the new packet to the second device. In this case, because the first device transfers (or transmits) all incoming packets to the second device without separate management, the first device does not need to perform flow management, and because the first device does not store the incoming packet queue, calculation may be reduced and the memory may be utilized efficiently.

### (4) Perform the Remaining Processing Other Than Some Packet Processing Performed by the Second Device

The second device processing packet processing may determine so that the first device performing packet processing receives a packet in which partial processing has been performed from the second device and performs the remaining processing. The method (4) is different from the method (3) in that the first device does not perform a process of forwarding a new packet to the second device.

For example, when there are at least two first devices that perform some functions of the second device performing packet processing (e.g., there may be a device 1-1 performing packet processing, a device 1-2 performing packet processing, a device 1-3 performing packet processing), some first devices may process newly incoming packets, and some other first devices may process packets transmitted to the UE (or outgoing from the BS). In this case, after performing some packet processing, the second device may determine to process only packets transmitted to the UE (or outgoing from the BS) for a first device.

Thereafter, in step 1030, the first device performing the packet processing may perform full packet processing of the new packet based on the determined packet processing method (the determination result of step 1020).

Alternatively, in step 1040, the first device performing the packet processing may perform some packet processing of the new packet based on the determined packet processing method (the determination result of step 1020), and then transmit (or transfer) the packet to the second device performing the packet processing.

Alternatively, in step 1050, the first device performing the packet processing may forward the new packet to the second device performing the packet processing based on the determined packet processing method (the determination result of step 1020). Thereafter, in step 1060, the second device may receive the processed packet and perform some packet processing procedures.

Alternatively, in step 1070, the first device performing the packet processing may receive a packet in which the second device has performed some packet processing based on the determined packet processing method (the determination result of step 1020), and perform the remaining processing other than some packet processing performed by the second device.

FIGS. 11A to 11C are diagrams illustrating a packet processing procedure according to an embodiment.

With reference to FIGS. 11A to 11C, a method in which a first device performing packet processing and a second device performing packet processing perform packet processing is illustrated.

The first device performing packet processing is not limited to physical equipment, is a device that receives a packet processing allocation request from the second device performing packet processing, and may include an SND. The second device performing packet processing is also not limited to physical equipment, and may include any one of a BS, a VM, or a V-CU in which SW is offloaded onto a virtualized platform.

Hereinafter, in FIGS. 11A to 11C, the first device performing packet processing will be described based on an SND, and the second device performing packet processing will be described based on a VM, but the scope of the disclosure is not limited thereto.

Specifically, FIG. 11A illustrates an embodiment of first packet processing (high-speed packet processing in CU with SND).

A VM 1101 may allocate full packet processing for a specific flow to an SND 1105.

A new packet may be entered into the SND 1105. The SND 1105 may determine whether the new packet corresponds to a flow allocated from the VM 1101 for the entered (or incoming) packet.

If the incoming packet is a packet corresponding to a flow allocated from the VM 1101, the SND 1105 may perform low-latency and high-speed packet processing on the newly incoming packet. More specifically, the SND 1105 may perform a series of packet processing procedures performed in UDP, SDAP, GTP-U, PDCP, and UDP layers on the newly incoming packet. Thereafter, the SND 1105 may transmit the finally processed packet to the UE.

If the incoming packet is not a packet corresponding to a flow allocated from the VM 1101, the SND 1105 transfers (transmits or sends) the incoming packet to the VM 1101. Thereafter, the VM 1101 may perform packet processing (e.g., packet processing in the UDP, GTP-U, SDAP, GTP-U, PDCP, UDP layers) and transmit the packet to the UE.

FIG. 11B illustrates second packet high-speed ingress packet processing in CU with SND according to an embodiment.

A VM 1101 may allocate packet processing for an incoming (or entered) flow to an SND 1105.

A new packet may be entered into the SND 1105. The SND 1105 may perform low-latency and high-speed packet processing for the corresponding flow for the incoming (or entered) packet.

The SND 1105 may perform processing only up to some layers for newly incoming packets. For example, the SND 1105 may perform processing only up to the PDCP layer corresponding to security for the incoming packets and transmit the processed packets to the VM 1101. Thereafter, the VM 1101 may perform user datagram protocol (UDP) packet processing after the PDCP layer and finally transmit the processed packets to the UE.

FIG. 11C illustrates a packet processing procedure using an SND according to another embodiment of the disclosure (High-speed egress packet processing in CU with SND).

A VM 1101 may allocate packet processing for an outgoing flow to an SND 1105.

A new packet may be entered (or may come in) to the SND 1105. The SND 1105 may forward all incoming packets to the VM 1101.

The VM 1101 may process packets forwarded (or entered) from the SND 1105 at a user datagram protocol (UDP) layer and then identify whether the processed packets are packets of a flow allocated to the SND 1105.

When the packet processed by the VM 1101 corresponds to a packet of a flow allocated to the SND 1105, the packet processed by the VM 1101 may be transmitted to the SND 1105. Thereafter, the SND 1105 may perform low-latency and high-speed packet processing on the packet of the flow requested from the VM 1101. More specifically, the SND 1105 may perform a series of packet processing procedures performed in the GTP-U, SDAP, GTP-U, PDCP, and UDP layers. Thereafter, the SND 1105 may transmit the processed packet to the UE.

When the packet processed by the VM 1101 is not a packet of a flow allocated to the SND 1105, the VM 1101 may transmit the packet to the UE after processing (e.g., packet processing in the UDP, GTP-U, SDAP, GTP-U, PDCP, UDP layers).

FIG. 12 illustrates a security context update procedure according to an embodiment.

Referring to FIG. 12, a procedure is provided for updating a security context when the security context is updated between a first device performing packet processing and a second device performing packet processing (security context update).

The first device performing packet processing is not limited to physical equipment, is a device that receives a packet processing allocation request from the second device performing packet processing, and may include an SND. The second device performing packet processing is also not limited to physical equipment, and may include any one of a BS, a VM, or a V-CU in which SW is offloaded onto a virtualized platform.

When the security context is updated, a second device 1203 performing packet processing needs to perform security context update to a first device 1201 performing packet processing.

In step 1210, the second device 1203 performing packet processing may transmit a security context update request message to the first device 1201 performing packet processing. More specifically, the second device 1203 performing packet processing may update a security context (or security key) and then transmit a security context update request message including the updated security context (or security key) to the first entity 1201 performing packet processing.

In step 1220, the first entity 1201 performing the packet processing may update the received security context (or security key) based on the received security context update request message.

In step 1230, the first entity 1201 performing the packet processing may transmit a security context update response message including the update result to the second entity 1203 performing the packet processing.

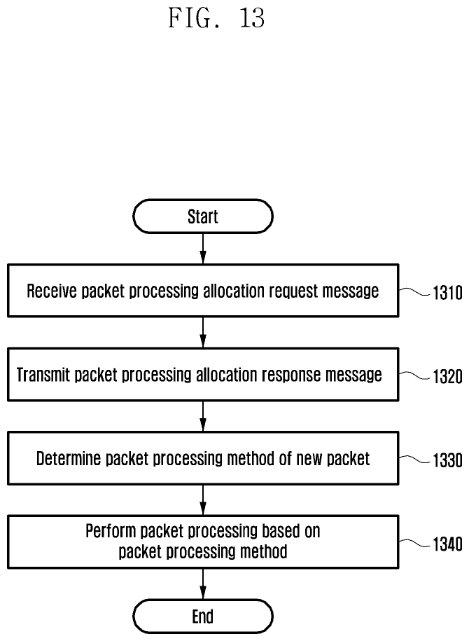

FIG. 13 illustrates a packet processing sequence of a first device performing packet processing according to an embodiment.

Referring to FIG. 13, a packet processing operation of the first device performing packet processing is illustrated. The first device performing packet processing is not limited to physical equipment, is a device that receives a request for packet processing allocation from a second device performing packet processing, and may include an SND.

In step 1310, the first device performing packet processing may receive a packet processing allocation request message from the second device (e.g., VM) performing packet processing.

As described above, the packet processing allocation request message may include at least one of a flow identifier, information related to allocation or exclusion of allocation (of a specific flow), a flow context, a security context, or flow requirements. The packet processing allocation request message may include reference information (or context) for distinguishing traffic. For example, the reference information for distinguishing traffic may include one or more of UE information (e.g., UE context), flow information (e.g., PDU session information, SDAP information, PDCP information, TCP/UDP/IP information, QUIC information), or security information (e.g., gNB security context, IPsec information).

In step 1320, the first device performing the packet processing may transmit a packet processing allocation response message to the second device performing the packet processing.

As described above, the packet processing allocation response message may determine whether allocation of processing requested from the second device performing the packet processing (or whether packet processing may be performed) and then transmit a packet processing allocation response message including whether processing allocation is acceptable (OK or not OK). Additionally, when the first device performing the packet processing transmits Not Ok, the first device may transmit together the reason for unacceptability of packet processing allocation (e.g., no remaining capacity, or unsatisfactory flow requirement, and the like).

In step 1330, the first device performing the packet processing may determine a packet processing method for a newly incoming packet.

More specifically, the first device performing the packet processing may determine a processing method of a newly incoming packet based on information included in the packet processing allocation request message. For example, the first device may determine whether to perform full packet processing process of the newly incoming packet, perform some packet processing and then transmit (or transfer) the packet to the second device, or forward the packet to the second device.

Thereafter, in step 1340, the first device performing the packet processing may perform packet processing according to the determined packet processing method.

For example, if a newly incoming packet is a packet corresponding to a flow allocated from the second device, the first device may perform low-latency and high-speed packet processing on the newly incoming packet. The first device may perform processing on the newly incoming packet only up to some layers. Alternatively, the first device may forward the newly incoming packet to the second device, and then receive the packet partially processed by the second device, perform low-latency and high-speed packet processing of the packet, and then transmit the packet to the UE.

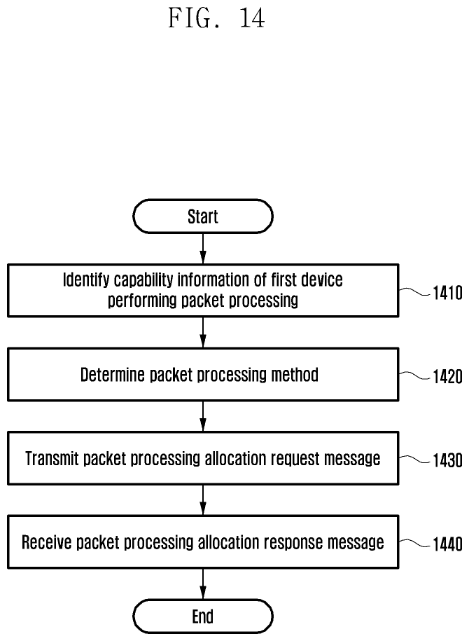

FIG. 14 illustrates a packet processing sequence of a second device performing packet processing according to an embodiment.

Referring to FIG. 14, a packet processing operation of the second device performing packet processing is illustrated. The second device performing packet processing is not limited to physical equipment, and may include any one of a BS, a VM, or a V-CU in which SW is offloaded onto a virtualized platform.

In step 1410, the second device performing packet processing may identify capability information of the first device performing packet processing.

More specifically, the second device performing packet processing may inquire the capability on whether a specific encryption algorithm and mode are available or whether a capacity is possible to the first device performing packet processing. The second device performing packet processing may identify whether availability and capacity of a TEE of the first device performing packet processing.

In step 1420, the second device performing the packet processing may determine a packet processing method based on capability information of the first device.

More specifically, the second device may determine to enable the first device to perform the entire process of packet processing for a specific flow. Alternatively, the second device may determine to perform some packet processing on the specific flow and then to transmit (or transfer) the packet to the second device or may determine to forward the packet to the second device for the specific flow and then to transmit (or transfer) the packet to the first device to perform packet processing.

In step 1430, when the second device performing the packet processing determines to allocate packet processing, the second device may transmit a packet processing allocation request message to the first device for performing the packet processing.

As described above, the packet processing allocation request message may include at least one of a flow identifier, information related to allocation or exclusion of allocation (of a specific flow), a flow context, a security context, or flow requirements. The packet processing allocation request message may include reference information (or context) for distinguishing traffic. For example, the reference information for distinguishing traffic may include one or more of UE information (e.g., UE context), flow information (e.g., PDU session information, SDAP information, PDCP information, TCP/UDP/IP information, QUIC information), or security information (e.g., gNB security context, IPsec information).

In step 1440, the second device performing the packet processing may receive a packet processing allocation response message from the first device performing the packet processing.

As described above, the packet processing allocation response message may include information on whether the second device performing the packet processing may accept the packet processing allocation (OK or not OK). Further, when the packet processing allocation response message includes Not Ok, the packet processing allocation response message may include information on the reason for unacceptability of packet processing packet processing allocation (e.g., no remaining capacity, or unsatisfactory flow requirements, and the like).

Thereafter, the second device performing the packet processing may perform packet processing of the newly incoming packet according to the previously determined packet processing allocation method. For example, when the newly incoming packet is a packet determined to enable the first device to perform processing only up to some layers and the second device to perform subsequent processing, the first device may receive a packet in which processing only up to some layers has been performed, perform subsequent packet processing, and then transmit the packet to the UE.

Alternatively, after receiving (or transferring) a newly incoming packet, the second device may perform some packet processing procedures (e.g., perform an UDP layer), and then identify whether the processed packet is a packet of a flow allocated to the first device. If the packet does not correspond to a flow determined to be processed by the first device, the second device may perform a packet processing procedure and transmit the packet to the UE. If the packet corresponds to a flow determined to be processed by the first device, the second device may transmit (or transfer) the packet to the first device.

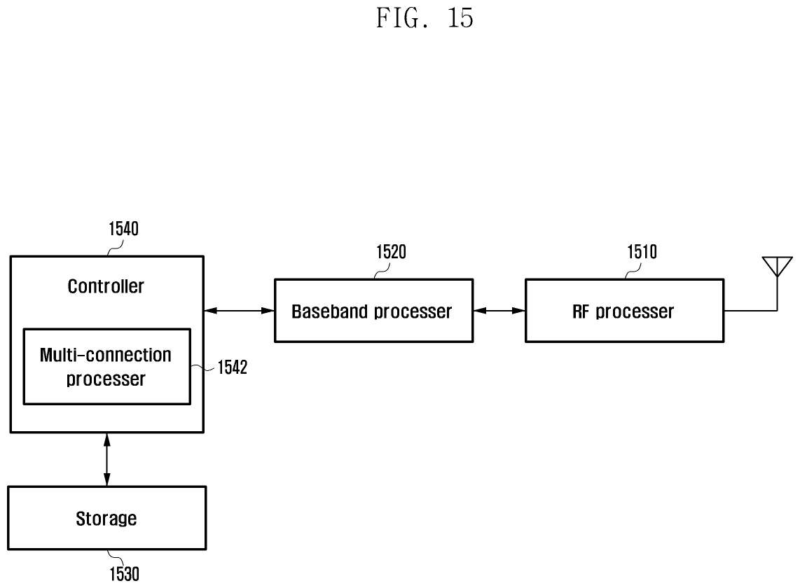

FIG. 15 illustrates an internal structure of a first device performing packet processing according to an embodiment.

As described above, the first device performing packet processing may include an SND. The SND indicates a network device having a special function capable of performing calculations in addition to established functions thereof. In addition to an existing packet processing function, the SND has logic capable of performing special calculations, and may improve a packet processing performance or perform calculation for a desired purpose by utilizing the logic existing in the SND. The SND may include a smart NIC, a programmable switch ASIC, and a net field programmable gate array (NetFPGA).

In FIG. 15, the first device performing the packet processing includes an RF processer 1510, a baseband processer 1520, a storage 1530, and a controller 1540.

The RF processer 1510 performs functions for transmitting and receiving signals through a wireless channel such as signal band conversion and amplification. That is, the RF processer 1510 up-converts a baseband signal provided from the baseband processer 1520 into an RF band signal, transmits the RF band signal through an antenna, and down-converts an RF band signal received through the antenna into a baseband signal. For example, the RF processer 1510 may include a transmission filter, a reception filter, an amplifier, a mixer, an oscillator, a digital to analog convertor (DAC), an analog to digital convertor (ADC), and the like. In the drawing, only one antenna is illustrated, but the UE may have multiple antennas. The RF processer 1510 may include multiple RF chains. Furthermore, the RF processer 1510 may perform beamforming. For the beamforming, the RF processer 1510 may adjust a phase and size of each of signals transmitted and received through multiple antennas or antenna elements. The RF processer may perform MIMO and receive multiple layers when performing a MIMO operation.

The baseband processer 1520 performs a conversion function between a baseband signal and a bit string according to physical layer specifications of the system. For example, when transmitting data, the baseband processer 1520 encodes and modulates a transmission bit string to generate complex symbols. Further, when receiving data, the baseband processer 1520 demodulates and decodes a baseband signal provided from the RF processer 1510 to restore a reception bit string. For example, in the OFDM method, when transmitting data, the baseband processer 1520 encodes and modulates a transmission bit string to generate complex symbols, maps the complex symbols to subcarriers, and then constitutes OFDM symbols through an inverse fast Fourier transform (IFFT) calculation and cyclic prefix insertion. Further, when receiving data, the baseband processer 1520 divides the baseband signal provided from the RF processer 1510 into OFDM symbol units, restores signals mapped to subcarriers through fast Fourier transform (FFT) calculation, and then restores the received bit string through demodulation and decoding.

The baseband processer 1520 and the RF processer 1510 transmit and receive signals, as described above. Accordingly, the baseband processer 1520 and the RF processer 1510 may be referred to as a transmitter, a receiver, a transceiver, or a communication unit. Furthermore, at least one of the baseband processer 1520 or the RF processer 1510 may include a plurality of communication modules so as to support a plurality of different wireless access technologies. At least one of the baseband processer 1520 or the RF processer 1510 may include different communication modules so as to process signals of different frequency bands. For example, the different wireless access technologies may include a wireless LAN (e.g., IEEE 802.11), a cellular network (e.g., LTE), etc. The different frequency bands may include super high frequency (SHF) (e.g., 2. NRHz, NRhz) bands, millimeter wave (mm wave) (e.g., 60 GHz) bands.

The storage 1530 stores data such as basic programs, application programs, and configuration information for an operation of the first device performing the packet processing. In particular, the storage 1530 may store information related to a second access node performing wireless communication using second wireless access technology. The storage 1530 provides stored data according to a request from the controller 1540.

The controller 1540 controls the overall operations of the first device performing the packet processing. For example, the controller 1540 transmits and receives signals through the baseband processer 1520 and the RF processer 1510. The controller 1540 records and reads data in the storage 1530. To this end, the controller 1540 may include at least one processor. For example, the controller 1540 may include a communication processor performing the control for communication and an application processor that controls upper layers such as application programs.

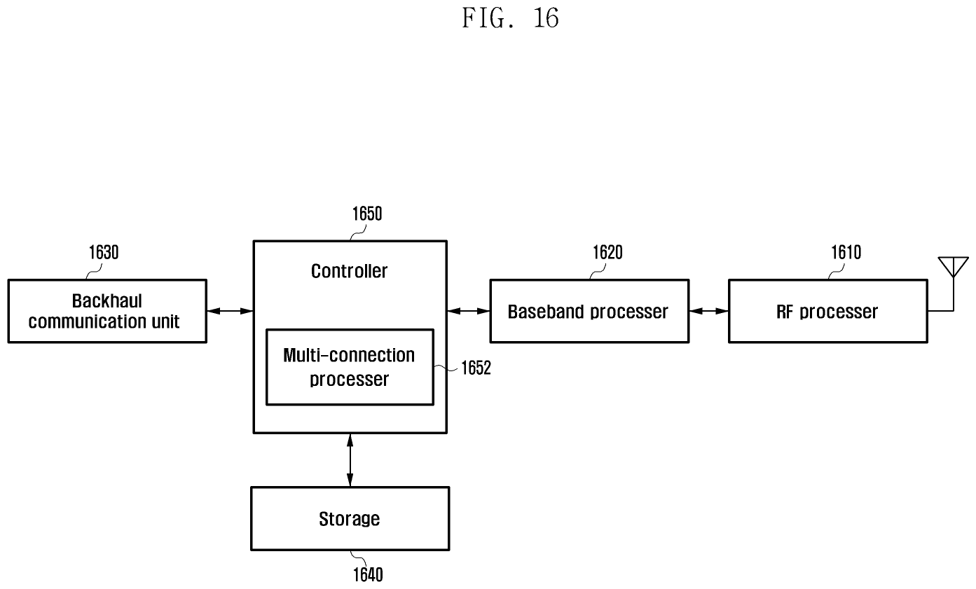

FIG. 16 illustrates an internal structure of a second device performing packet processing according to an embodiment.

A device performing packet processing in this specification means a device capable of performing packet processing calculations, and means a device capable of performing general calculations, control, input/output, and various complex calculations. The device performing packet processing may include a server, a server dedicated memory, a CPU, a memory, and a chipset for managing and controlling peripheral devices.

In FIG. 16, the second device performing the packet processing includes an RF processer 1610, a baseband processer 1620, a backhaul communication unit 1630, a storage 1640, and a controller 1650.

The RF processer 1610 performs functions for transmitting and receiving signals through a wireless channel such as signal band conversion and amplification. That is, the RF processer 1610 up-converts a baseband signal provided from the baseband processer 1620 into an RF band signal, transmits the RF band signal through an antenna, and down-converts an RF band signal received through the antenna into a baseband signal. For example, the RF processer 1610 may include a transmission filter, a reception filter, an amplifier, a mixer, an oscillator, a DAC, an ADC, etc. In the drawing, only one antenna is illustrated, but a first access node may have multiple antennas. The RF processer 1610 may include multiple RF chains. Furthermore, the RF processer 1610 may perform beamforming. For the beamforming, the RF processer 1610 may adjust a phase and size of each of signals transmitted and received through multiple antennas or antenna elements. The RF processer may transmit one or more layers to perform a downward MIMO operation.

The baseband processer 1620 performs a conversion function between a baseband signal and a bit string according to physical layer specifications of first wireless access technology. For example, when transmitting data, the baseband processer 1620 may encode and modulate a transmission bit string to generate complex symbols. When receiving data, the baseband processer 1620 demodulates and decodes a baseband signal provided from the RF processer 1610 to restore a reception bit string. For example, in following the OFDM method, when transmitting data, the baseband processer 1620 encodes and modulates a transmission bit string to generate complex symbols, maps the complex symbols to subcarriers, and then constitutes OFDM symbols through an IFFT calculation and cyclic prefix insertion. Further, when receiving data, the baseband processer 1620 divides the baseband signal provided from the RF processer 1610 into OFDM symbol units, restores signals mapped to subcarriers through FFT calculation, and then restores the received bit string through demodulation and decoding. The baseband processer 1620 and the RF processer 1610 transmit and receive signals, as described above. Accordingly, the baseband processer 1620 and the RF processer 1610 may be referred to as a transmitter, a receiver, a transceiver, a communication unit, or a RF unit.

The backhaul communication unit 1630 provides an interface for performing communication with other nodes within the network. That is, the backhaul communication unit 1630 converts a bit string transmitted from a second device performing packet processing to another node, for example, an auxiliary BS or a CN, into a physical signal, and converts a physical signal received from the other node into a bit string.

The storage 1640 stores data such as basic programs, application programs, and configuration information for the operation of the second device performing the packet processing. In particular, the storage 1640 may store information on bearers allocated to accessed UEs, measurement results reported from accessed UEs, and the like. The storage 1630 may store information that serves as a determination criterion on whether to provide or terminate multiple connections to the UE. The storage 1630 provides stored data according to a request from the controller 1650.

The controller 1650 controls the overall operations of the second device performing the packet processing. For example, the controller 1650 may transmit and receive signals through the baseband processer 1620 and the RF processer 1610 or through the backhaul communication unit 1630. The controller 1650 records and reads data in the storage 1630. To this end, the controller 1650 may include at least one processor.

Methods according to the embodiments described herein may be implemented in the form of hardware, SW, or a combination of hardware and SW.

In being implemented in SW, a computer readable storage medium storing one or more programs (SW modules) may be provided. One or more programs stored in the computer readable storage medium are configured for execution by one or more processors in an electronic device. The one or more programs include instructions for causing the electronic device to execute methods according to embodiments of the disclosure.

Each block of flowcharts and combinations of the flowcharts may be performed by computer program instructions. Because these computer program instructions may be mounted in a processor of a general purpose computer, a special purpose computer, or other programmable data processing equipment, instructions performed by a processor of a computer or other programmable data processing equipment generate a means that performs functions described in the flowchart block(s). Since these computer program instructions may be stored in a computer usable or computer readable memory that may direct a computer or other programmable data processing equipment to implement a function in a particular manner, the instructions stored in the computer usable or computer readable memory may produce a production article containing instruction means for performing the function described in the flowchart block(s). Because the computer program instructions may be mounted on a computer or other programmable data processing equipment, a series of operation steps are performed on the computer or other programmable data processing equipment to generate a computer-executable process; thus, instructions for performing the computer or other programmable data processing equipment may provide steps for performing functions described in the flowchart block(s).

Each block may represent a portion of a module, a segment, or a code including one or more executable instructions for executing a specified logical function(s). In some alternative implementations, functions recited in the blocks may occur out of order. For example, two blocks illustrated one after another may in fact be performed substantially simultaneously, or the blocks may be sometimes performed in the reverse order according to the corresponding function.

In this case, a term -unit used in this embodiment means SW or hardware components such as a field programmable gate array (FPGA) or an application specific integrated circuit (ASIC), and -unit performs certain roles. However, -unit is not limited to SW or hardware. -unit may be constituted to reside in an addressable storage medium or may be constituted to reproduce one or more processors. Therefore, as an example, -unit includes components such as SW components, object-oriented SW components, class components, and task components, processes, functions, properties, procedures, subroutines, segments of program code, drivers, firmware, microcode, circuit, data, databases, data structures, tables, arrays, and variables. Functions provided in the components and -units may be combined into a smaller number of components and -units or may be further separated into additional components and -units. Components and -units may be implemented to reproduce one or more CPUs in a device or secure multimedia card.

Such programs (SW modules, SW) may be stored in a random access memory, a non-volatile memory including a flash memory, a read only memory (ROM), an electrically erasable programmable ROM (EEPROM), a magnetic disc storage device, a compact disc-ROM (CD-ROM), DVDs, any other form of optical storage device, or a magnetic cassette. Alternatively, the programs may be stored in a memory composed of a combination of some or all thereof. Further, each constitution memory may be included in the plural.

The program may be stored in an attachable storage device that may access through a communication network such as the Internet, Intranet, local area network (LAN), wide LAN (WLAN), or storage area network (SAN), or a communication network composed of a combination thereof. Such a storage device may access to a device implementing an embodiment of the disclosure through an external port. Further, a separate storage device on a communication network may access to a device implementing the embodiment of the disclosure.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a first device performing packet processing in a mobile communication system, the method comprising:
receiving, from a second device performing packet processing, a packet processing allocation request message requesting packet processing;
receiving a packet;
determining a packet processing method of the received packet based on the packet processing allocation request message; and
performing packet processing of the received packet based on the determined packet processing method.

2. The method of claim 1, wherein the packet processing allocation request message comprises at least one of packet reference information, flow identifier, flow allocation information, or flow requirement information,
wherein the packet reference information comprises at least one of terminal information, flow information, or security information,
wherein the terminal information comprises a terminal context,
wherein the flow information comprises at least one of protocol data unit (PDU) session information, service data adaption protocol (SDAP) information, packet data convergence protocol (PDCP) information, transmission control protocol (TCP) information, user datagram protocol (UDP) information, Internet protocol (IP) information, or quick DUP Internet connection (QUIC) information, and
wherein the security information comprises at least one of base station security information or security key information.

3. The method of claim 2, further comprising transmitting a packet processing allocation response message to the second device performing the packet processing,
wherein the packet processing allocation response message further comprises information on whether packet processing allocation is acceptable.

4. The method of claim 1, wherein the first device is configured to perform functions of packet processing performed by the second device,
wherein the first device comprises a smart network device (SND), and
wherein the second device comprises a virtual machine (VM).

5. The method of claim 1, further comprising:
receiving, from the second device performing packet processing, a capability request message of the first device performing packet processing; and
transmitting, to the second device performing the packet processing, a first device capability response message,
wherein the first device capability response message comprises at least one of available encryption algorithm and mode information of the first device or trusted execution environment (TEE) support information of the first device.

6. The method of claim 1, wherein the packet processing method comprises:
performing full processing of a received packet by the first device,
performing partial processing of a received packet by the first device and then transmitting the packet to the second device, or
forwarding a received packet to the second device by the first device and then performing partial processing.

7. A method performed by a second device performing packet processing in a mobile communication system, the method comprising:
identifying a capability of a first device performing packet processing;
determining a packet processing method based on the capability of the first device performing the packet processing; and
transmitting, to the first device performing packet processing, a packet processing allocation request message requesting packet processing based on the determined packet processing method.

8. The method of claim 7, wherein the packet processing allocation request message comprises at least one of packet reference information, flow identifier, flow allocation information, or flow requirement information,
the packet reference information comprises at least one of terminal information, flow information, or security information,
the terminal information comprises a terminal context,
the flow information comprises at least one of protocol data unit (PDU) session information, service data adaption protocol (SDAP) information, packet data convergence protocol (PDCP) information, transmission control protocol (TCP) information, user datagram protocol (UDP) information, Internet protocol (IP) information, or quick DUP Internet connection (QUIC) information,
the security information comprises at least one of base station security information or security key information,
the first device is configured to perform some functions of packet processing performed by the second device,
the first device comprises a smart network device (SND), and
the second device comprises a virtual machine (VM).

9. The method of claim 7, further comprising receiving, from the first device performing the packet processing, a packet processing allocation response message,
wherein the packet processing allocation response message further comprises information on whether packet processing allocation is acceptable.

10. The method of claim 7, further comprising:
transmitting, to the first device performing the packet processing, a capability request message of the first device performing the packet processing; and
receiving, from the first device performing the packet processing, a first device capability response message,
wherein the first device capability response message comprises at least one of available encryption algorithm and mode information of the first device or trusted execution environment (TEE) support information of the first device, and
the packet processing method comprises a method of performing full processing of a received packet by the first device, a method of performing partial processing of a received packet by the first device and then transmitting the packet to the second device, or a method of forwarding a received packet to the second device by the first device and then performing partial packet processing.

11. A first device for performing packet processing in a mobile communication system, the first device comprising:
a transceiver configured to transmit and receive signals; and
a controller,
wherein the controller is configured to:
receive a packet processing allocation request message requesting packet processing from a second device performing packet processing,
receive a packet,
determine a packet processing method of the received packet based on the packet processing allocation request message, and
perform packet processing of the received packet based on the determined packet processing method.

12. The first device of claim 11, wherein the packet processing allocation request message comprises at least one of packet reference information, flow identifier, flow allocation information, or flow requirement information,
the packet reference information comprises at least one of terminal information, flow information, or security information,
the terminal information comprises a terminal context,
the flow information comprises at least one of protocol data unit (PDU) session information, service data adaption protocol (SDAP) information, packet data convergence protocol (PDCP) information, transmission control protocol (TCP) information, user datagram protocol (UDP) information, Internet protocol (IP) information, or quick DUP Internet connection (QUIC) information, and
the security information comprises at least one of base station security information or security key information.

13. The first device of claim 12, wherein the controller is configured to transmit a packet processing allocation response message to the second device performing the packet processing, and
the packet processing allocation response message further comprises information on whether packet processing allocation is acceptable.

14. The first device of claim 11, wherein the first device is configured to perform some functions of packet processing performed by the second device,
the first device comprises a smart network device (SND), and
the second device comprises a virtual machine (VM).

15. The first device of claim 11, wherein the controller is configured to:
receive a capability request message of the first device performing the packet processing from the second device performing packet processing, and
transmit a first device capability response message to the second device performing packet processing,
wherein the first device capability response message comprises at least one of available encryption algorithm and mode information of the first device or a trusted execution environment (TEE) support information of the first device.

16. The first device of claim 11, wherein the packet processing method comprises:
a method of performing full processing of a received packet by the first device,
a method of performing partial processing of a received packet by the first device and then performing partial processing by the second device, or
a method of receiving forwarding of a received packet by the first device, performing processing, and performing partial processing by the first device.

17. A second device for performing packet processing in a mobile communication system, the second device comprising:
a transceiver configured to transmit and receive signals; and
a controller,
wherein the controller is configured to:
identify a capability of a first device performing packet processing,
determine a packet processing method based on the capability of the first device performing the packet processing, and
transmit a packet processing allocation request message requesting packet processing to the first device performing the packet processing based on the determined packet processing method.

18. The second device of claim 17, wherein the packet processing allocation request message comprises at least one of packet reference information, flow identifier, flow allocation information, or flow requirement information,
the packet reference information comprises at least one of terminal information, flow information, or security information,
the terminal information comprises a terminal context,
the flow information comprises at least one of protocol data unit (PDU) session information, service data adaption protocol (SDAP) information, packet data convergence protocol (PDCP) information, transmission control protocol (TCP) information, user datagram protocol (UDP) information, Internet protocol (IP) information, or quick DUP Internet connection (QUIC) information,
the security information comprises at least one of base station security information or security key information,
the first device is configured to perform some functions of packet processing performed by the second device,
the first device comprises a smart network device (SND), and
the second device comprises a virtual machine (VM).

19. The second device of claim 17, further comprising receiving, from the first device performing the packet processing, a packet processing allocation response message,
wherein the packet processing allocation response message further comprises information on whether packet processing allocation is acceptable.

20. The second device of claim 17, wherein the controller is configured to:
transmit a capability request message of the first device performing the packet processing to the first device performing the packet processing, and
receive a first device capability response message from the first device performing the packet processing,
wherein the first device capability response message comprises at least one of available encryption algorithm and mode information of the first device or trusted execution environment (TEE) support information of the first device, and
the packet processing method comprises a method of performing full processing of a received packet by the first device, a method of performing partial processing of a received packet by the first device and then performing partial processing by the second device, or a method of receiving forwarding of a received packet by the first device, performing processing, and then performing partial processing by the first device.
